(19) United States
(12) Patent Application Publication
(10) Pub. No.: US 2009/0008340 A1
(43) Pub. Date: Jan. 8, 2009

(54) Method for Evaporating a Process Stream Comprising at Least Two Components

(75) Inventors: Heinz Bauer, Ebenhausen (DE); Barbara Buttinger, Muenchen (DE); Thomas Hecht, Gauting (DE); Rainer Sapper, Aufkirchen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/817,352

(22) PCT Filed: Feb. 28, 2006
(86) PCT No.: PCT/EP2006/001806

§ 371 Date: May 27, 2008

(30) Foreign Application Priority Data
Mar. 4, 2005 (DE) 10 2005 010 051.1

(51) Int. Cl. B01D 1/00

(52) U.S. Cl. 210/767

(57) ABSTRACT

A method of evaporating a process stream is disclosed. In an embodiment, a process stream to be cooled is provided to a heat exchanger. A process stream to be evaporated is provided to the heat exchanger. A gas and/or a liquid is admixed with the process stream to be evaporated only when an amount of gas generated during evaporation of the process stream cannot entrain a liquid portion of the process stream to be evaporated. A gas is generated by the admixing.

### BACKGROUND AND SUMMARY OF THE INVENTION

This application claims the priority of International Application No. PCT/EP2006/001806, filed Feb. 28, 2006, and German Patent Document No. 10 2005 010 051.1, filed Mar. 4, 2005, the disclosures of which are expressly incorporated by reference herein.

The invention relates to a process for operating the heat exchange between at least one process stream to be cooled and at least one, at least two-component process stream to be evaporated, wherein the process stream taken to the heat exchange to be evaporated undergoes vertical evaporation.

In a great number of highly varied processes, such as the liquefaction of natural gas, the extraction of olefins, hydrogen separation in the cold part of ethylene plants, in hydrogen and nitrogen washes, in condensate preparation processes, etc., mixtures are evaporated in heat exchangers. This evaporation can be carried out from top to bottom or from bottom to top; the latter is known as “vertical evaporation” or “standing evaporation”. One or more hot process streams, which are cooled by the evaporating mixture, are brought in as “heating medium.”

If vertical evaporation can be implemented, the liquid of the process stream to be evaporated can be transported upwards evenly in the heat exchanger only if the volume of gas generated in the evaporation is sufficiently great. While a process is being started, or during partial load operation, there is always the risk that the volume of gas generated in the heat exchanger during evaporation is not sufficient to prevent enrichment of the heavy components of the mixture to be evaporated. If this is the end effect, the process stream or process streams to be cooled cannot be cooled adequately—the heat exchanger cannot perform its task. In an instance like this, the heat exchanger is said to have gone into “sleep mode”.

In addition, if there is too low a gas load, or volume, there can also be an uneven flow through the heat exchanger. Because of this uneven flow, the temperatures inside the heat exchanger vary and the result is an increase in undesirable mechanical load. In extreme cases, the increases in load induced by this uneven distribution can be so great that the result is a mechanical failure of the heat exchanger.

In different processes, such as natural gas liquefaction processes, mixed streams are condensed and cooled, while another and/or the same mixture is evaporated at a lower pressure. During the start-up procedure in these processes as well unacceptable mechanical loads can occur on the basis of too great temperature differences between hot and cold mixtures and/or because of too rapid cooling of the mixtures.

The object of the present invention is to specify a generic process which ensures an entrainment at any time in adequate quantities of the liquid portion of the process stream to be evaporated.

To achieve this object, a generic process is provided which is characterized in that at least when the gas portion generated during evaporation is so small that entrainment of the liquid portion of the process stream to be evaporated can no longer be ensured, a gas, a gas mixture, a gas/liquid mixture and/or a single- or multi-component liquid which generates a gas or gas mixture when mixed with the process stream to be evaporated is admixed to the process stream to be evaporated prior to its introduction into the heat exchanger and/or prior to the beginning of the heat exchange, wherein the admixed amount of gas is measured at least such that entrainment of the liquid part of the process stream to be evaporated is ensured.

By means of the process in accordance with the invention, it is ensured that even during start-up and part-load operation entrainment of the liquid part of the process stream to be evaporated is guaranteed at all times. Mechanical overloading of the heat exchanger can thus be effectively prevented. Even the previously described “sleep mode” of a heat exchanger can be prevented by means of the process in accordance with the invention.

Additional embodiments of the process in accordance with the invention are characterized in that:

the gas, gas mixture, gas/liquid mixture and/or single- or multi-component liquid fed to the process stream to be evaporated is drawn from the process stream to be evaporated before and/or after it is evaporated, and

the gas, gas mixture, gas/liquid mixture and/or single or multi-component liquid fed to the process stream to be evaporated has an identical composition to the process stream to be evaporated.

With respect to the temperatures of the process stream to be evaporated as well as of the gas, gas mixture, gas/liquid mixture and/or single- or multi-component liquid to be fed in, they can either be (approximately) the same or different. (Approximately) the same temperatures are advantageous with small differences in temperatures inside the apparatus, or heat exchanger, since the effective operating temperature difference is not reduced. During start-up in particular, however, large temperature differences can arise between the hot and the cold process streams which result in additional mechanical loads in the apparatus. By feeding a hot gas stream into the process stream to be evaporated, the temperature difference and thus the mechanical load is reduced.

The process in accordance with the invention and additional embodiments of the process are explained in greater detail using the embodiments shown in FIGS. 1 to 5.

### BRIEF DESCRIPTION OF THE DRAWINGS

FIGS. 1 to 5 illustrate alternative embodiments of the present invention.

### DETAILED DESCRIPTION OF THE DRAWINGS

A heat exchanger E is shown in FIGS. 1 to 5, which is preferably an upright tube/jacket heat exchanger, a plate heat exchanger and/or a coil heat exchanger.

Via line 1 a single- or multi-component process stream is brought to this heat exchanger E to be cooled, which, after it is cooled and if necessary (partially) condensed in the heat exchanger E, is extracted via line 1′.

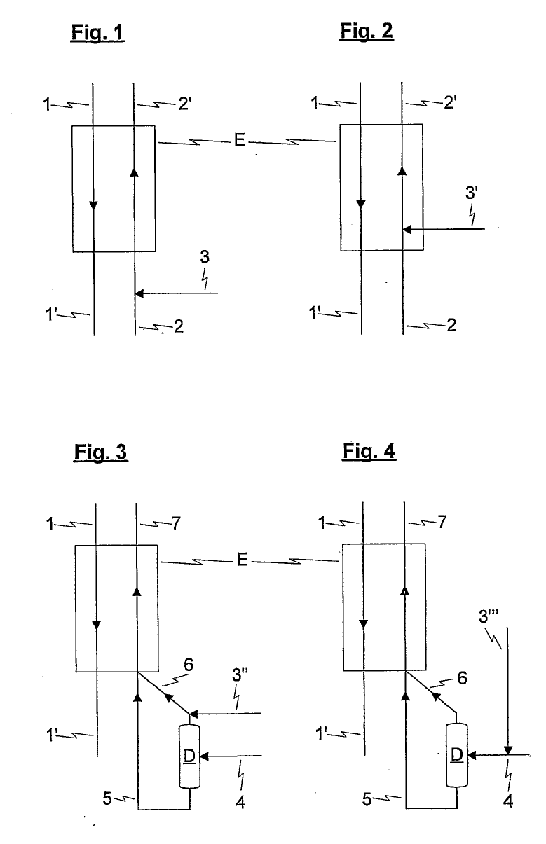

In the embodiments shown in FIGS. 1 and 2 the process stream to be evaporated is taken to heat exchanger E via line 2 and extracted from the heat exchanger via line 2′ when evaporation is completed.

In accordance with the embodiment shown in FIG. 1, a gas, gas mixture, gas/liquid mixture and/or a single- or multi-component liquid can be fed via line 3 to the process stream in line 2 in accordance with the invention. This method of performing the process is preferably chosen if no 2-phase distribution is required for the 2-phase feed into the apparatus, or heat exchanger E.

In the embodiment shown in FIG. 2 the previously described feed is via line 3′ at the beginning of the heat exchange between the process stream 2 to be evaporated and the process stream 1 to be cooled. This method of performing the process has special advantages when the process stream 2 which is to be evaporated has a low gas percentage and the stream fed in via a separate device in the apparatus, or heat exchanger E, is combined with the process stream 2 to be evaporated.

As already mentioned, the gas, gas mixture, gas/liquid mixture and/or multi-component liquid taken to the process stream to be evaporated can have an identical composition to the process stream to be evaporated or a different composition suitable for the particular application.

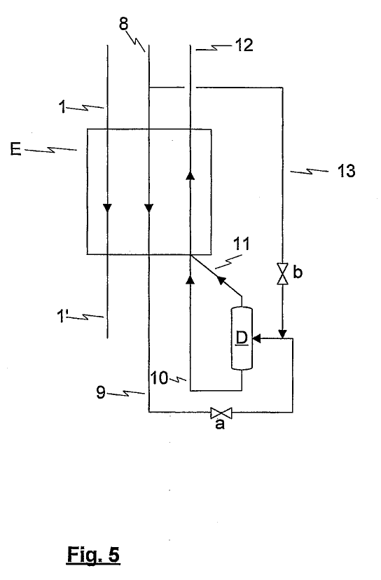

Shown in FIGS. 3 and 4 are two further embodiments of the process in accordance with the invention in which the process stream to be evaporated is taken via line 4 to a separator D and undergoes phase separation in the separator. A liquid fraction is taken from the sump of the separator D via line 5 and a gaseous fraction is withdrawn from the head of the separator D via line 6. These two fractions are reunited in the entry area of heat exchanger E and are drawn off through line 7 after passing through the heat exchanger E. This method of performing the phase separation process and subsequent reunification makes sense particularly when the compounds of the stream, or liquid 3″, to be fed in and of the process stream to be evaporated are similar, so that no additional gas is generated when the aforementioned process streams are brought together. This method of performing has the advantage that the separator D can have smaller dimensions.

The feeding of a gas, gas mixture, gas/liquid mixture and/or a single- or multi-component liquid now takes place via line 3″ into the gas phase drawn off at the head of the separator D via line 6—as shown in FIG. 3—or through/via line 3′″ into the process stream to be evaporated before it is taken to phase separation D.

The procedure shown in FIG. 4 has particular advantages when process streams 4 and 3′″ have great differences in temperature and/or very different compositions, since good mixing of the two previously mentioned process streams 4 and 3′″ can be achieved even before phase separation in the separator D using this procedure.

An additional embodiment is shown in FIG. 5, such as can be applied, for example, as part of a natural gas liquefaction process.

In this, the process stream to be evaporated later which is taken to the heat exchanger E via line 8 is first cooled in the heat exchanger and partially condensed. Then it is drawn off from heat exchanger E via line 9, expanded in valve a while providing refrigeration and undergoes phase separation in separator D.

As already explained using the embodiments shown in FIGS. 3 and 4, a liquid fraction is withdrawn from the sump of separator D via line 10 and a gaseous fraction is withdrawn from the head of separator D via line 11 and taken jointly to heat exchanger E and reunited. The partially evaporated process stream is then drawn off via line 12 from heat exchanger E.

In accordance with the invention, a partial stream of the process stream taken via line 8 to heat exchanger E via line 13 is drawn off, expanded in valve b and admixed to the cooled process stream in line 9 prior to phase separation D.

It is further conceivable that a separator not shown in FIG. 5 is provided in line 8 in which the process stream to be cooled undergoes phase separation prior to its introduction into heat exchanger E. While the liquid fraction extracted in the phase separation is taken to the heat exchanger E for the purpose of cooling, a partial stream of the gaseous fraction obtained at the head of phase separation is taken in its entirety via line 13 and expansion valve b—as shown in FIG. 5—to the process stream in line 9 prior to phase separation.

1-4. (canceled)

5. A process for operating a heat exchange between at least one process stream to be cooled and at least one two-component process stream to be evaporated, wherein the process stream taken to the heat exchange to be evaporated undergoes vertical evaporation, wherein only when an amount of gas generated during evaporation is so low that entrainment of a liquid portion of the process stream to be evaporated is no longer ensured, a gas, a gas mixture, a gas/liquid mixture and/or a single- or multi-component liquid which generates a gas or a gas mixture when admixed with the process stream to be evaporated is fed to the process stream to be evaporated before being taken to the heat exchange and/or at a beginning of the heat exchange, wherein an amount fed is measured such that entrainment of the liquid portion of the process stream to be evaporated is ensured.

6. The process according to claim 5, wherein the heat exchange takes place in a vertical tube/sheath heat exchanger, plate exchanger and/or a coil heat exchanger.

7. The process according to claim 5, wherein the gas, gas mixture, gas/liquid mixture and/or single- or multi-component liquid fed to the process stream to be evaporated is drawn from the process stream to be evaporated before and/or after it is evaporated.

8. The process according to claim 5, wherein the gas, gas mixture, gas/liquid mixture and/or single- or multi-component liquid fed to the process stream to be evaporated has an identical composition to the process stream to be evaporated.

9. A method of evaporating a process stream, comprising the steps of:
providing a process stream to be cooled to a heat exchanger;
providing a process stream to be evaporated to the heat exchanger;
admixing a gas and/or a liquid with the process stream to be evaporated only when an amount of gas generated during evaporation of the process stream cannot entrain a liquid portion of the process stream to be evaporated; and
generating a gas by the step of admixing.

10. The method according to claim 9, wherein the gas and/or the liquid is admixed to the process stream to be evaporated prior to the process stream to be evaporated entering the heat exchanger.

11. The method according to claim 9, wherein the gas and/or the liquid is admixed to the process stream to be evaporated in the heat exchanger.

12. The method according to claim 9, wherein the gas and/or the liquid is admixed to a gaseous fraction of the process stream to be evaporated.

13. The method according to claim 9, further comprising the step of phase separating the process stream to be evaporated and wherein the gas and/or the liquid is admixed to the process stream to be evaporated prior to the step of phase separating.

14. The method according to claim 9, wherein the step of admixing the gas and/or the liquid with the process stream to be evaporated includes the step of providing a portion of the process stream to be evaporated to the process stream to be evaporated after the process stream to be evaporated passes through the heat exchanger.
